(19) United States
(12) Patent Application Publication
(10) Pub. No.: US 2008/0246612 A1
(43) Pub. Date: Oct. 9, 2008

(54) Hand-held tester

(75) Inventor: Ying-Chang Liu, Taipei Hsien (TW)

Correspondence Address: TROXELL LAW OFFICE PLLC, Suite 1404, 5205 Leesburg Pike, Falls Church, VA, 22041, US

(73) Assignee: CHENG LOONG CORPORATION

(21) Appl. No.: 11/783,276

(22) Filed: Apr. 6, 2007

(51) Int. Cl. G08B 1/00

(52) U.S. Cl. 340/572.4

(57) ABSTRACT

A hand-held tester includes a testing kit and a measuring machine, wherein the testing kit has, mounted thereon, a wave absorbing material, an emitting antenna, and a RFID tag. The wave absorbing material is mounted around the inner side of the testing kit, and the emitting antenna and the RFID tag are disposed at the opposite sides of the testing kit, and further, the measuring machine and the testing kit are electrically connected, thereby a benefit way to find the best position for adhering the RFID tag can be achieved.

### FIELD OF THE INVENTION

The present invention is related to a hand-held tester, which, through disposing a RFID (Radio Frequency Identification) tag and an emitting antenna at the opposite sides thereof, can find the best position for adhering a RFID tag, so that it is suitable for sensing the objects like cardboards, packing cases and gift cases . . . etc.

### BACKGROUND OF THE INVENTION

The RFID technology has been well developed and the application scope thereof also becomes wider and wider, and since the biggest retailer in the whole world “Wal-Mart” had requested the suppliers to adhere a RFID tag to the packing cases and the pallets, the requiring of RFID packing case absolutely will have a great growth. Furthermore, the adhering process of the RFID tag by the delivery company is gradually replacing by the manufacturer of packing cases, so that the development of the packing case with RFID tag should have an immediate attention.

It should be known that the fabrication of RFID packing cases is not just to put the RFID tag on the packing case, it actually has to consider the volume size of and the contents in the packing case which may both influence the position of the RFID tag, and it also has to find the best position of the RFID tag by testing for obtaining a better reading efficiency. Currently, this kind of testing technology is to, place by place, measure the position of packing case through the RFID reader and to analyze the signal intensity by a spectrum analyzer, for obtaining the smallest reflection power or the strongest response signal, thereby finding the best adhering position of the RFID tag.

However, the method described above depends on complicated steps, expensive equipments, and unchangeable measuring location. Consequently, owing to the technical defects described above, the applicant keeps on carving unflaggingly through wholehearted experience and research to develop a hand-held tester, which has simplified testing process, low cost and convenient measuring mode.

### SUMMARY OF THE INVENTION

The object of the present invention is to provide a hand-held tester which, through disposing a RFID tag and an emitting antenna at the opposite sides of a testing kit thereof, can sense the signal intensities from all surfaces around a packing case, so as to locate the best adhering position of the RFID tag and therefore increase convenience and practicability.

Another object of the present invention is to provide a hand-held tester which, through mounting a wave absorbing material inside a testing kit thereof, can avoid frequency interference during testing, so as to improve reading efficiency and also the sensing accuracy of signal intensity from all surfaces of the packing case.

Further another object of the present invention is provide a hand-held tester to which, through simplifying testing process and structure, can be moved to every position of the packing case as needed, so as to increase the convenience and practicability.

For achieving the objects described above, the present invention provides a hand-held tester including a testing kit and a measuring machine, wherein the testing kit has, mounted thereon, a wave absorbing material, an emitting antenna, and a RFID tag. The wave absorbing material is mounted around the inner side of the testing kit, and the emitting antenna and the RFID tag are disposed at the opposite sides of the testing kit, and further, the measuring machine and the testing kit are electrically connected, thereby a benefit way to find the best position for adhering the RFID tag can be achieved.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a three-dimensional drawing showing the appearance of an embodiment in the present invention;

FIG. 2 is a schematic view showing the usage of an embodiment in the present invention; and

FIG. 3 is a sectional drawing showing an embodiment of the present invention.

### DESCRIPTION OF THE PREFERRED EMBODIMENT

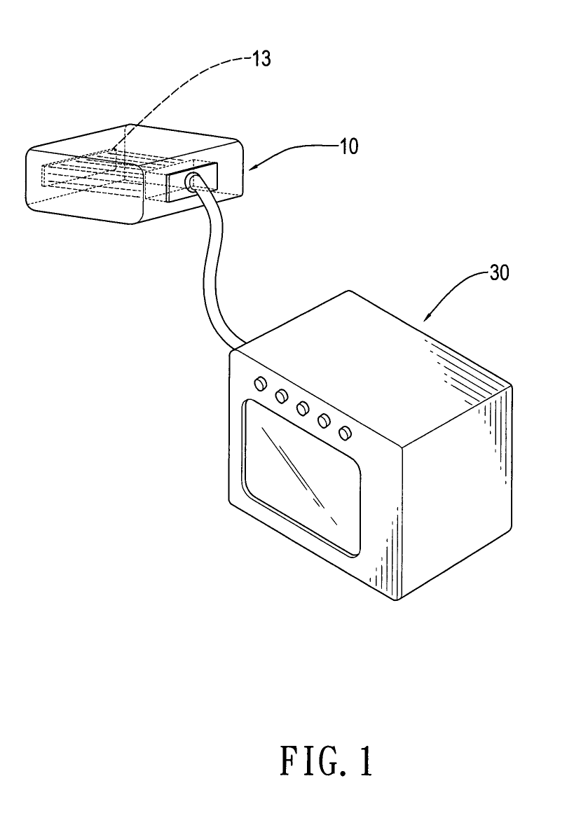

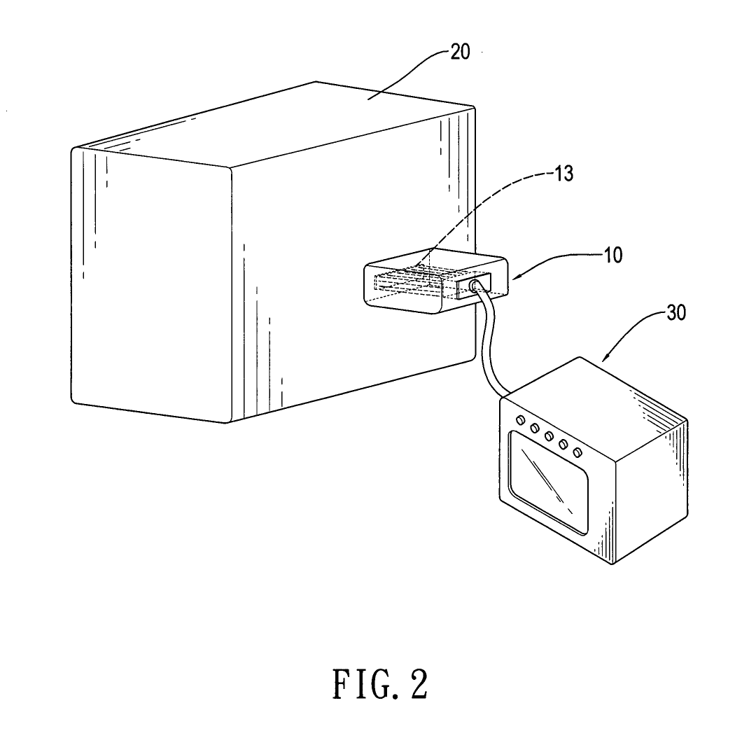

Please refer to FIGS. 1 to 3, the hand-held tester according to the present invention includes a testing kit 10 and measuring machine 30, wherein the testing kit 10 has, mounted thereon, a wave absorbing material 11, an emitting antenna 12, and a RFID tag 13. The wave absorbing material 11 is mounted around the inner side of the testing kit 10, and the emitting antenna 12 and the RFID tag 13 are disposed at the opposite sides of the testing kit 10, wherein the distance between the emitting antenna 12 and the RIFD tag 13 is approximately ranged from 5 cm to 70 cm and is determined by the measuring frequency. Here, the RFID tag is a passive tag, which is induced by the external electromagnetic wave or electric wave to generate electricity for transmitting data, so that there is no need to equip battery, thereby achieving the advantages of small volume, low price and long life. Besides, the passive tag can be a read-only, a rewritable and a write-once passive tag, and has a frequency ranged from 400 MHz to 2.5 GHz. As to the measuring machine 30, it includes a control unit, a switching unit, an amplifier and an attenuator. The measuring machine 30 is electrically connected to the testing kit 10 for controlling the testing kit 10 and also actuating the reading mechanism of the testing kit 10. Then, when the testing kit 10 reads the data from the object 20 to be measured, it will transmit the data back to the measuring machine 30.

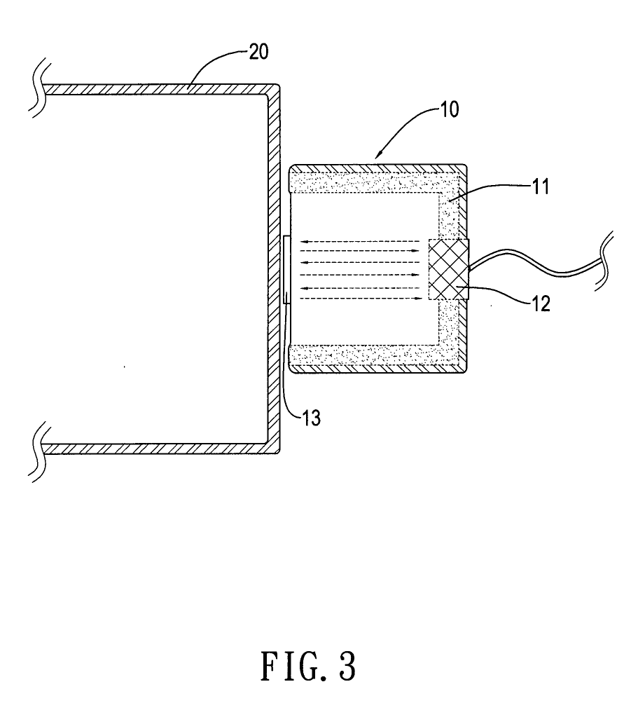

Please refer to FIG. 3. The characteristics of the present invention are that, through the wave absorbing material mounted inside the testing kit 10, the frequency interference during the testing can be avoided so as to increase the reading efficiency and also contribute to an accurate sensing of the signal intensity from all surfaces around the object 20, and through disposing the RFID tag 13 and the emitting antenna 12 at the opposite sides of the testing kit 10, the testing kit 10 can have a flat contact with the object 20 (in this embodiment, a cardboard case), so that the RFID 13 on the testing kit 10 can be close to the surface of the object 20 for sensing the signal intensity from all surfaces around the object 20, thereby finding the reading problem caused from the volume size and the different contents therein, so as to locate the best position for adhering the RFID tag 13 and thus increase the performance of the RFID packing case. In addition, the RFID tag 13 can replace by similar products from different manufacturers in the market so as to adapt to the real situation.

Please refer to FIGS. 1 to 3. When measuring, the object 20 is located in front of the testing kit 10, and since the testing kit 10 is electrically connected to the measuring machine 30, the measuring machine 30 can control the testing kit 10 and actuate the reading mechanism thereof, so as to receive and analyze the data from the testing kit 10, or the measuring machine 30 can be further connected to other relative reading equipment for analyzing the data. Besides, when measuring, the testing kit 10 should contact the object 20 as close as possible, so that the RFID tag 13 on the testing kit 10 can be close to the surface of the object 20, and then, the testing kit 10 moves around the surfaces of the objects 20 for sensing the signal intensities therefrom so as to locate the best position of the RFID tag 13.

In the aforesaid, the present invention has advantages that:

1. Through the RFID tag and the emitting antenna disposed at the opposite sides of the testing kit, the testing kit can sense the signal intensities around all surfaces of the packing case, so that a best position for the RFID tag can be located and also the reading efficiency of the RFID packing case can be increased.

2. The testing kit can cooperate with all kinds of RFID readers and RFID tags in the market for sensing the response signal intensities from all surfaces around the packing case, can be applied to particular frequency or multiple frequencies, and can be cooperated with various packing cases and contents in different materials, such as, metal, liquid, glass, plastic . . . etc.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hand-held tester comprising:
a testing kit, wherein the testing kit has, mounted thereon, a wave absorbing material, an emitting antenna, and a RFID tag, in which the wave absorbing material is mounted around the inner side of the testing kit, and the emitting antenna and the RFID tag are disposed at the opposite sides of the testing kit; and
a measuring machine, wherein the measuring machine and the testing kit are electrically connected, thereby benefiting to find a best position for adhering the RFID tag.

2. A hand-held tester as claimed in claim 1, wherein the length of the testing kit is ranged from 5 cm to 70 cm.

3. A hand-held tester as claimed in claim 1, wherein the frequency of RFID tag is ranged from 400 MHz to 2.5 GHz.

4. A testing kit of a hand-held tester comprising:
a wave absorbing material, wherein the wave absorbing material is mounted around the inner side of the testing kit; and
an emitting antenna and a RFID tag, wherein the emitting antenna and the RFID tag are disposed at the opposite sides of the testing kit.

5. A hand-held tester as claimed in claim 4, wherein the length of the testing kit is ranged from 5 cm to 70 cm.

6. A hand-held tester as claimed in claim 4, wherein the frequency of RFID tag is ranged from 400 MHz to 2.5 GHz.
